(19) United States
(12) Patent Application Publication
(10) Pub. No.: US 2017/0046532 A1
(43) Pub. Date: Feb. 16, 2017

(54) METHOD AND SYSTEM FOR DATE FILE ENCRYPTION, TRANSFER, DECRYPTION, AND PLAYBACK

(71) Applicant: J. Michael Miller, Livermore, CA (US)

(72) Inventor: J. Michael Miller, Livermore, CA (US)

(21) Appl. No.: 15/184,853

(22) Filed: Jun. 16, 2016

Related U.S. Application Data
(60) Provisional application No. 62/180,458, filed on Jun. 16, 2015.

(51) Int. Cl. G06F 21/62; H04L 29/06; H04L 9/08; G06F 21/60

(52) U.S. Cl. CPC G06F 21/6218; G06F 21/602; H04L 63/0478; H04L 9/0825; G06F 2221/2107

(57) ABSTRACT

A method and system for data file encryption and decryption using multiple public and private digital keys wherein no fully decrypted data files are stored on a computer device.

### TECHNICAL FIELD

The invention relates to digital computing devices, particularly to systems and methods for encrypting data files to prevent theft and piracy.

### CROSS REFERENCE TO RELATED APPLICATIONS

(Not applicable)

### STATEMENT REGARDING FEDERALLY SPONSORED RESEARCH OR DEVELOPMENT

(Not applicable)

### BACKGROUND OF THE INVENTION

Over the past decade, people have turned more and more to the Internet to purchase items. This is overwhelmingly the scenario when it comes to the purchase of music, movies, books and other multi-media entertainment. Today's computer users download many multi-media files through various computer-based multimedia applications such as iTunes®, Barnes & Noble's Nook®, Amazon's Kindle®, etc. The rise online purchases of music, etc., while certainly more convenient to consumers, has opened a whole new set of concerns for the owners of those works. The security of data files has become a very important issue to the owners and authors of digital works.

The theft of data files has led to the increase of data file security methods, among which, data file encryption is a widely used method. Data encryption involves taking the data file and encoding it so that only authorized parties can use the file by obtaining a “key’ to decrypt the data.

However, once a consumer downloads a data file and stores it on the hard drive of their computer, the consumer is able to access the file and strip the file of any protections the file may have. Therefore, the user can download a song file and then remove any digital protections on the file and then share the file with others freely. Thus, resulting in a loss of profit for the record label, Production Company, artist, etc. because the file will be available for free to people who normally have had to purchase the file in order to listen to it.

Therefore, a need exists for data file protection beyond the level of existing encryption methods. Particularly, a need exists to maintain the integrity of data file protection once the data file has be purchased by a consumer so as to prevent piracy of the data file.

### SUMMARY OF THE INVENTION

The present invention discloses a method for encrypting and decrypting music files using the following steps: generating a first public digital key and a first private digital key; encrypting a music file with said first public key; uploading said first public key encrypted music files to a server; storing said first public key encrypted music files in said server; packaging said first private key into a database file in a downloadable computer application; downloading said downloadable computer application with said packaged first private key onto a computer device; connecting said computer application with said server via a web server and a computer operating system which communicate using HTTP; requesting, via said computer application, that said first public key encrypted music file stored on said server to be sent to said computer device; encrypting said first public key encrypted music file with a second public key by said web server; sending said first and second public key encrypted music file from said server to said computer operating system through said web server; decrypting said second public key by said operating system using a second private key obtained via said HTTP communication process; downloading said first public key encrypted music file to said computer device; storing said first public key encrypted music on said computer device; requesting to access said first public key encrypted music file stored on said computer device by said computer application; decrypting said first public key encrypted music file stored on said computer device using said first private key packaged into said computer application; storing said decrypted music file on said computer device while said computer application plays said decrypted music file; and then deleting said decrypted music file from said computer device once said computer application has completed playback of said decrypted music file.

### BRIEF DESCRIPTION THE DRAWINGS

The operation of the invention will become apparent from the following description taken in conjunction with the drawings, in which:

FIG. 1 is an overview of a prior art method for downloading a data file to a computer device;

FIG. 2 is an overview of a prior art method for downloading a computer application to a computer device;

FIG. 3 is a flowchart of the inventive method for downloading a computer application to a computer device;

FIG. 4 is a flowchart of the inventive method for storing a data file on a server;

FIG. 5 is a flowchart of the inventive method for encrypting and transferring a data file from a remote server to a computer device;

FIG. 6 is a flowchart of the inventive method for playback of an encrypted data file on a computer device;

FIG. 7 is a flowchart of the development process of the inventive encryption system;

FIG. 8 is a flowchart of the user installation process of the inventive encryption system;

FIG. 9 is a flowchart of the inventive method for encrypting and transferring a data file; and

FIG. 10 is a flowchart of the inventive method for playback of an encrypted data file.

### DETAILED DESCRIPTION OF THE PREFERRED EMBODIMENTS

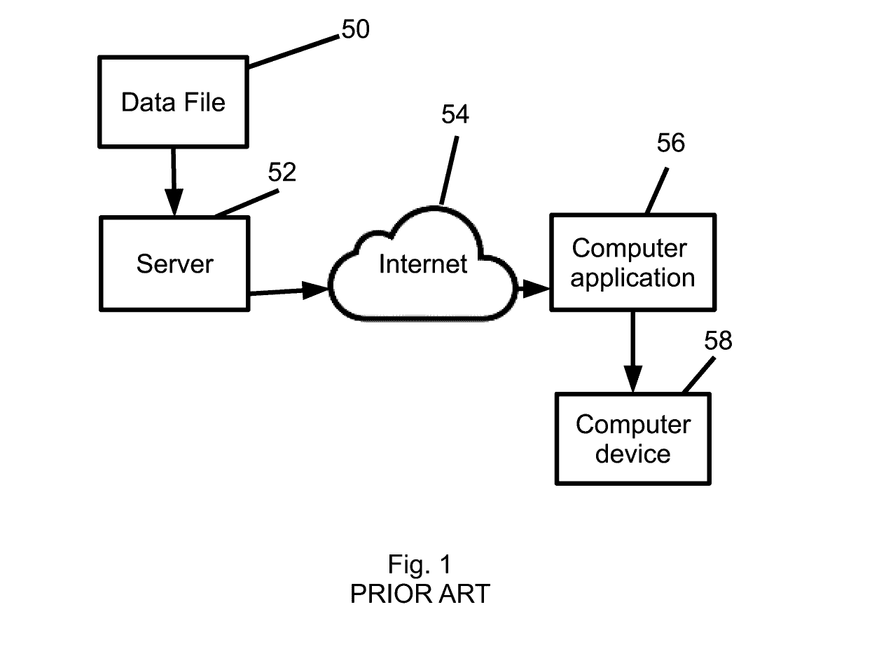

Referring to FIG. 1, an overview of the prior art method for downloading a data file is illustrated. In a typical download data file 50 would be stored on server 52. Data file 50 can be any type of data file such as .mov, .mp4, .m4v, .mp3, .wav, .mpeg, .jpg, .png, .aef, .epub, .lrf, .lrx, .cbr, .cbz, .cb7, .cbt, .cba, .chm, DAISY, .html, .djvu, .azw, .lit, .exe, etc. Server 52 could be located anywhere in the world and would be associated with a particular website or computer application such as iTunes®, Netflix®, Kindle®, etc. Data file 50 would be transmitted from server 52 via communications network 54, i.e. the Internet, to computer application 56. Computer application 56 would be associated with server 52. For example, computer application 56 might be iTunes®, and thus server 52 would be an iTunes® server. Once data file 50 has been transmitted to computer application 56, a user would then be able to transfer data file 50 to the user's computer device 58, such as a personal computer, laptop, tablet, or mobile phone, etc. Once data file 50 is transferred to the user's computer device 58, the user would be able to use, transfer, copy, edit, etc. data file 50 however the user wanted.

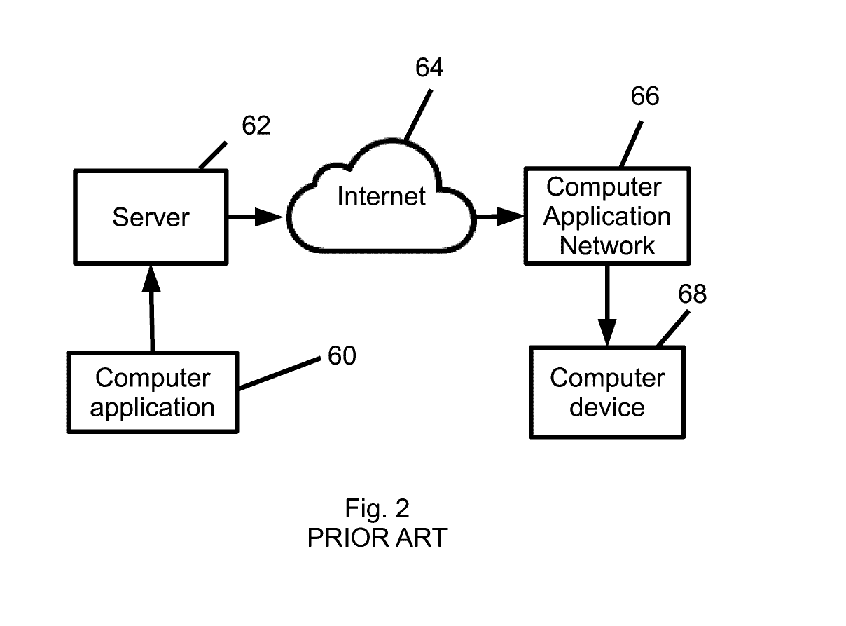

Referring to FIG. 2, an overview of the prior art method for downloading a computer application is illustrated. In a typical download computer application 60 would be stored on server 62. Computer application 60 could be any type of application such as a music application, a electronic book application, a game application, or a utility application like a calculator, etc. Server 52 could be located anywhere in the world and would be associated with a particular website, application store or any other electronic means of purchasing a computer application. Computer application 60 would be transmitted from server 62 via communications network 64, i.e. the Internet, to computer application network 66. Computer application network 66 would be associated with server 62. Once computer application 60 is transmitted to computer application network 66 it is then installed onto the disk drive of computer device 68. Computer device 68 may be any type of computer device such as a personal computer, laptop, tablet, or mobile phone, etc. Once computer application 60 is installed on computer device 68, a user would be able to access and use computer application 60 at any time on computer device 68 until the user uninstalls computer application 60.

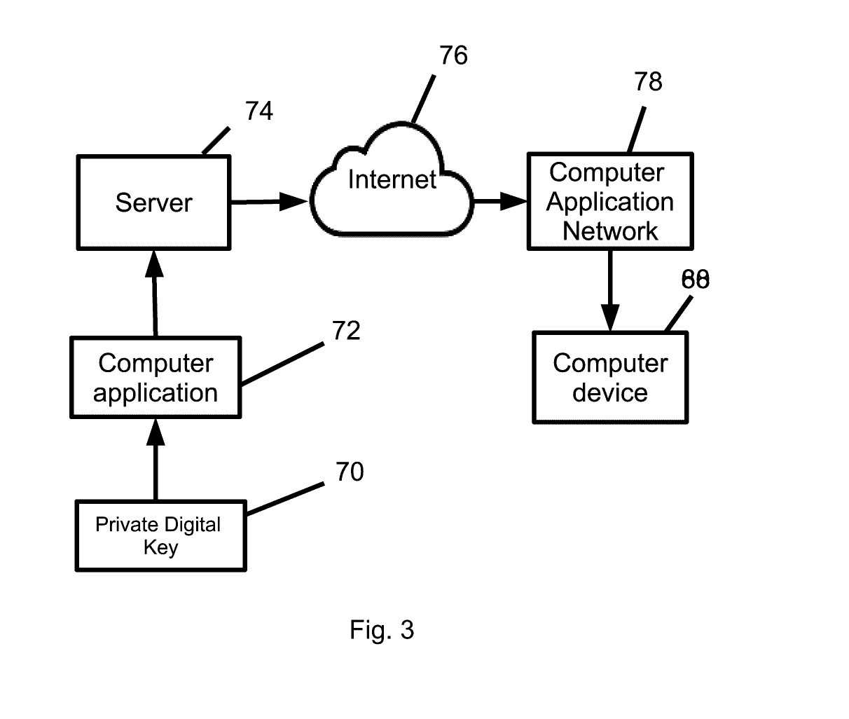

Referring now to FIG. 3, an overview of the inventive method for providing an encrypted computer application is illustrated. In contrast to the prior art method illustrated in FIG. 2 and described above, the inventive system provides a user with a computer application using Pretty Good Privacy (PGP) data encryption. In a preferred embodiment of the present invention public-key cryptography or asymmetric cryptography is used, a method well known in the art. In the inventive method a computer application with an embedded private digital key that will allow the computer application to read data files encrypted with the corresponding public key is provided to a user. A private digital key 70 is written into the code of computer application 72. Computer application 72 is then stored on server 74. Once a user purchases computer application 74, computer application 74 is transmitted via communications network 76, i.e. the Internet, to computer application network 78. Computer application network 78 may be a website or computer application store, such as iTunes. Once computer application 72 is transmitted to computer application network 78, computer application 72 is then installed on computer device 80. Computer device 80 may be any type of computer device such as a personal computer, laptop, tablet, or mobile phone, etc. Once computer application 72 is installed on computer device 80, a user would be able to access and use computer application 72 at any time on computer device 80 until the user uninstalls computer application 72. In contrast the prior art, computer application 72 remains embedded with a private digital key while installed on computer device 80.

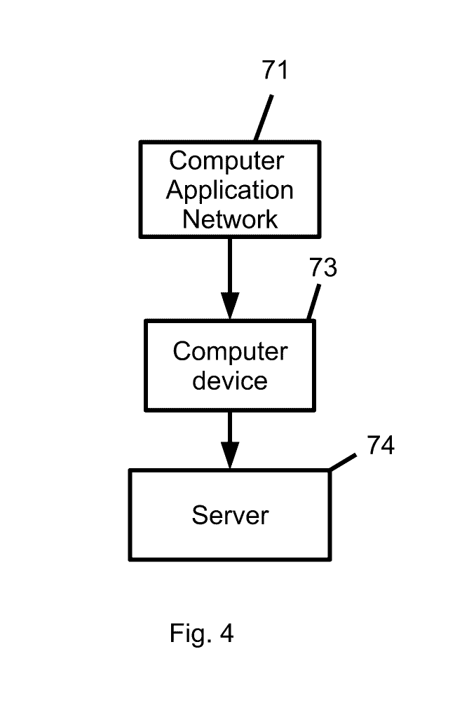

Once a user has installed computer application 72 with the private digital key embedded into the code of computer application 72, the user will then be able to purchase and download data filed. Referring now to FIG. 4, a simple overview of data file storage is illustrated. All data files to be stored on the inventive systems servers will be encrypted with a public key, which corresponds to the private digital key coded in computer application 72. Data file 71, which can be any file type such as a .mov, .mp4, .m4v, .mp3, .wav, .mpeg, .jpg, .png, .aef, .epub, .lrf, .lrx, .cbr, .cbz, .cb7, .cbt, .cba, .chm, DAISY, .html, .djvu, .azw, .lit, .exe, etc., is encrypted with a public encryption key 73. Once data file 71 has been encrypted with public encryption key 73, data file 71 is then stored on server 74. Server 74 may store a wide variety of data file types, a few different types of data files, or a single type of data file, such as an audio file. Server 74 may also store a library of different data files.

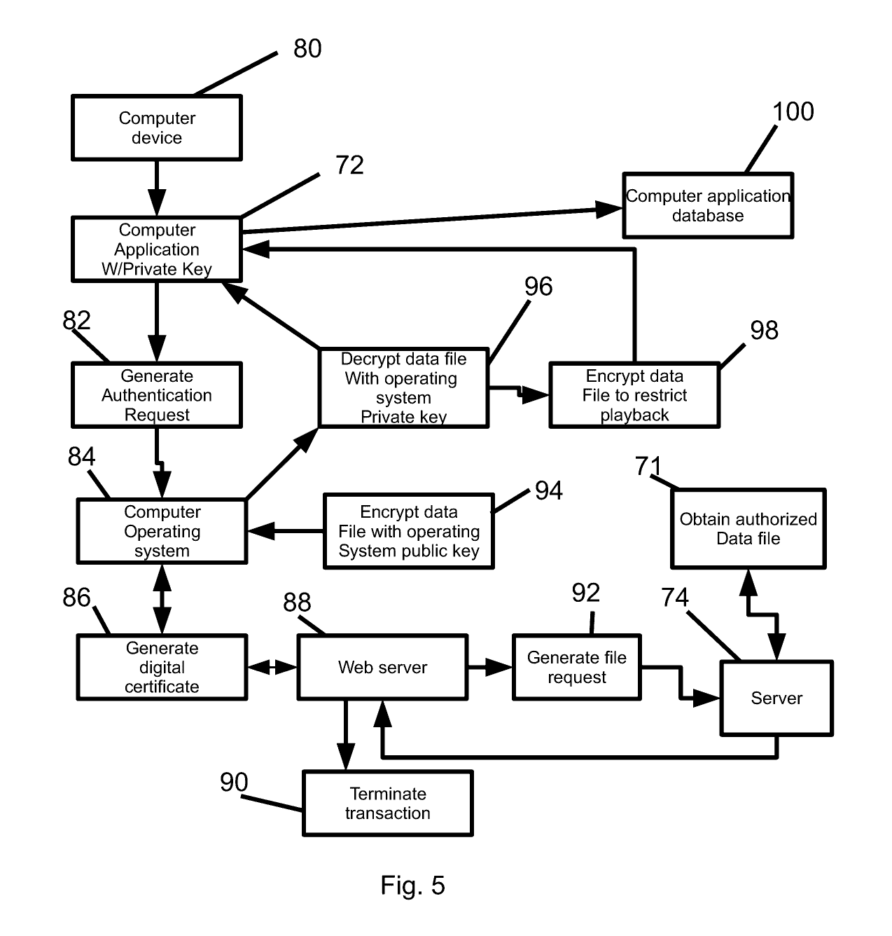

Once a user has installed computer application 72, the user will be able to purchase and download data files from server 74 to computer application 72 and then use the data files on the user's computer device. FIG. 5 illustrates the inventive method of downloading an encrypted data file such that the data file is stored in a computer application database in encrypted format until selected by the user. Thus, the inventive system and method provides a user with access to data files without storing those data files on the user's computer device. The primary purpose for this is to prevent theft and piracy of the data file by the user. Through the inventive system, the user will not be able to save the data file to the user's computer device and strip the data file of it protections so that the user can use, copy, edit, etc. the data file.

Referring to FIG. 5, the above method is illustrated. A user on computer device 80 will open computer application 72. Computer application 72 is encrypted with a private digital key as described above and illustrated in FIG. 3. Once a user has opened computer application 72, the user will be able to download a data file through purchase of the data file. Once the user has purchased a data file, computer application 72 will generate an authorization request 82. Authorization request 82 will be sent to computer operating system 84. This authorization request 82 will ask computer operating system 84 to connect with web server 88 via a secure connection such as hypertext transfer protocol secure (HTTPS). Computer operating system 84 will then generate a digital certificate 86. Digital certificate 86 will then be sent to web server 88. Once web server 88 has received digital certificate 86, web server 88 will either send a digital certificate 86 back to computer operating system 84 or send terminate signal 90.

If web server 88 proceeds to exchange digital certificates 86 with computer operating system 84, web server 88 will then transmit file request 92 to server 74. Server 74, upon receipt of file request 92, will then obtain authorized data file 71 from its database and transmit data file 71 back to web server 88. Web server 88 will then encrypt the data file with public key 94 of computer operating system 84. The data file will then be transmitted to computer operating system 84 via a secure pipeline created by the exchange of digital certificates 86. Once computer operating system 84 receives the now double-encrypted data file, encrypted once as illustrated in FIG. 4 and then again by web server 88 with public key 94, computer operating system 84 will then decrypt the data file with the private key 96 of computer operating system 84.

Once the data file has been decrypted by private key 96 of computer operating system 84 the system may proceed in one of two ways. In the preferred embodiment, the data file is encrypted a third time by operating system 84, so as to prevent other computer applications resident on computer device 80 from accessing the data file. Once the data file has been encrypted for the third time, the data file is then transmitted to computer application 72, which then stores the data file in computer application database 100.

After a user has downloaded encrypted data files from the server to the computer application database, the user will then be able to access the data file. However, the user will not have the same access to the file as the user would had he simply downloaded an un-encrypted data file. The encryption will limit what the user will be able to do with the data file. In a preferred embodiment of the present invention, audio files will be downloaded via the inventive system. The user will then be able to listen to these encrypted audio files on the user's computer device. However, the audio files will remain on the user's computer device once the audio file has ended.

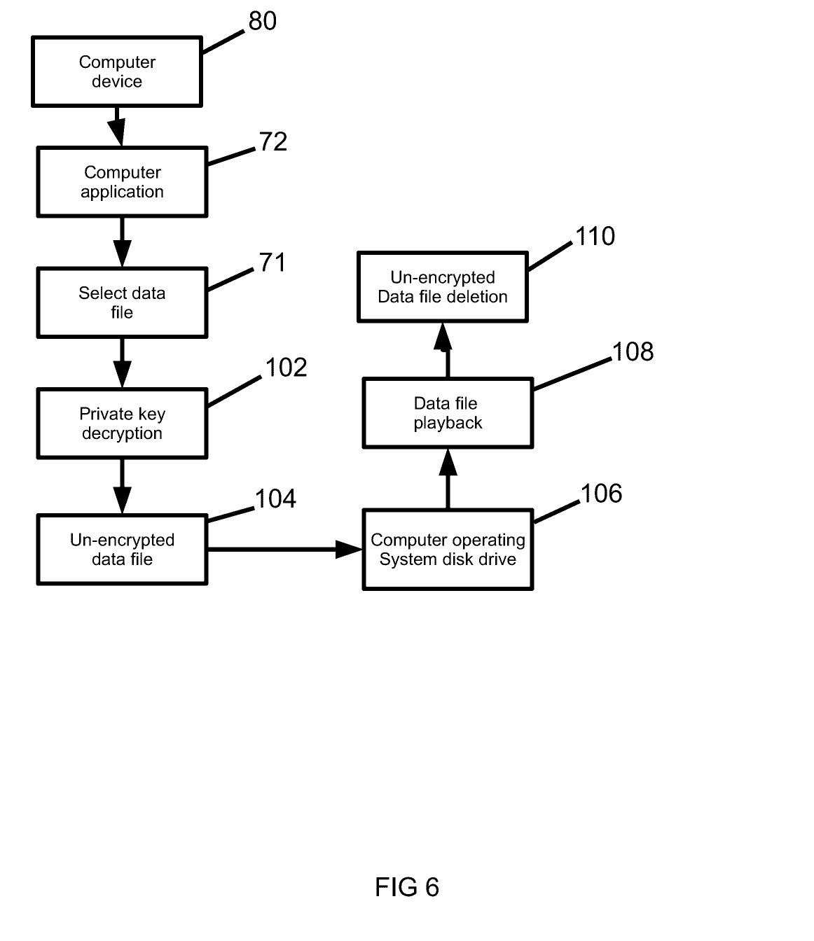

Referring now to FIG. 6, the inventive method of encrypted data file playback is illustrated. A user on computer device 80 opens computer application 72. The user will then select which data file the user wants to access from the computer application database. The data file is then decrypted by private digital key 102 resulting in un-encrypted data file 104. Un-encrypted data file 104 is then transmitted to computer operating system disk drive 106 where the user is able to play, read, watch, and/or listen to the data file. Once un-encrypted data file 104 has finished, it is deleted from computer operating system disk drive 106. Thus, all that remains is the encrypted data file resident in the computer application database.

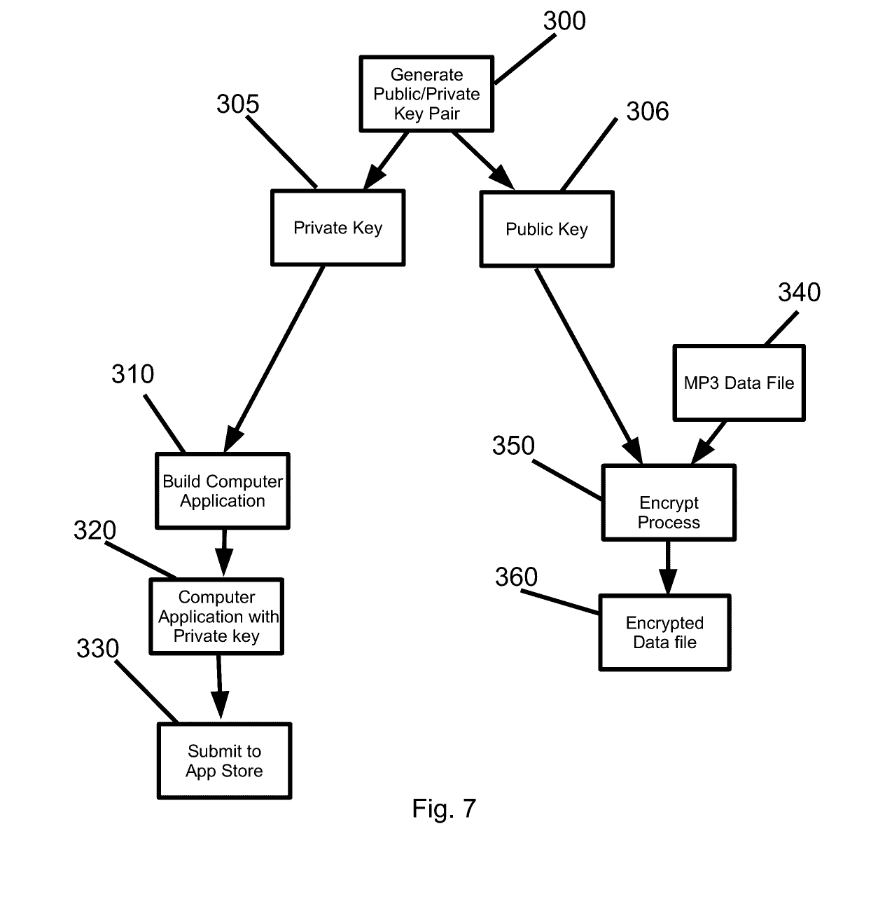

The development process of the inventive system is illustrated in FIG. 7. At step 300, a public digital key 305 and a private digital key 306 are generated that is specific to the inventive system. Public digital key 306 and private digital key 305 are used in tandem so that only the private digital 305 can decrypt data filed encrypted with the public digital key 306. Public digital key 306 encrypts a data file 340 at steps 350 producing an encrypted data file 360. FIG. 7 illustrates the process for a mp3 file, but any data file may be encrypted for use in the inventive system. Encrypted data file 260 can then be uploaded the inventive systems servers where is it will be stored on a disk drive. Private digital key 305 is packaged into a the inventive downloadable computer application 310 within a database file, which allows only for the downloadable computer application to access private digital key 305. Further protection of the private digital key is provided for by a computer operating system, which does not allow other computer applications to access the files of inventive downloadable computer application 310. Inventive downloadable application 310 will be available to users download to computer devices from computer applications store 330 such as the Apple® App Store®.

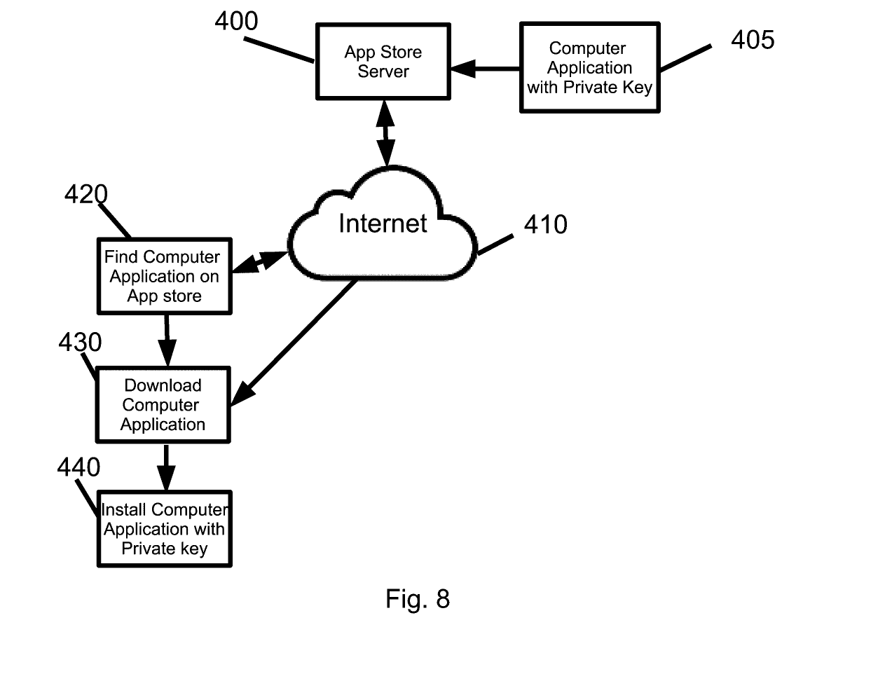

FIG. 8 illustrates the installation process for the inventive downloadable computer application. The inventive downloadable computer application with private key 405 is stored on a computer applications store server 400. At step 420, a user searches for downloadable computer application with private key 405 on their computer device via the Internet 410. Alternatively, a user may follow a unique URL link to downloadable computer application with private key 405 within computer applications store. A user will then download to his/her computer device downloadable computer application with private key 405 at step 430. Downloadable computer application with private key 405 will be downloaded on the user's computer device via the Internet from the computer application store server 400. Once downloaded to user's computer device, downloadable computer application with private key 405 will be installed on the computer device automatically by the operating system of the computer device.

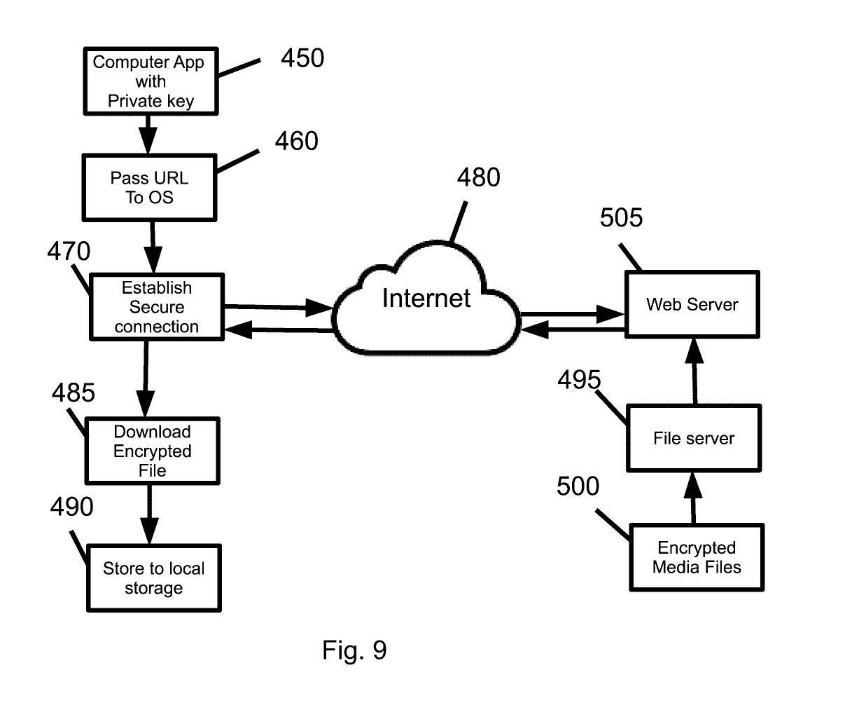

FIG. 9 illustrates the preferred embodiment of the inventive method and system. The user launches downloadable computer application with private key 450, which will then make an authentication request to a server to download the entitled data files. All network requests will leverage a computer operating system communication. Downloadable computer application with private key 450 will pass a pre-packaged URL at step 460 to a computer operating system to establish a connection. The operating system will to connect to web server 505 via HTTPS to establish a secure connection at step 460. This will be the standard HTTPS communication process. The operating system will connect to web server 505 running in a datacenter. Web server 505 has software called Apache Web Server running on port 443. The operating system and Apache Web Server will exchange their digital certificates which include a public key. This is a different set of public/private key (second pair of keys) than the originally generated public/private generated by the inventive system as illustrated in FIG. 7. Once the digital certificates have been exchanged, there will be a secure channel established between the operating system and Apache Web Server. Any information passed between the two computers will be encrypted by their respective public key. For example, if data is passed from the operating system to Apache, then the operating system will encrypt the data with Apache's public key. Once the data reaches Apache, Apache will use its own private key to decrypt the data. Apache Web Server will make a request to the file server 495 to get a specificed encrypted data file 500. File server 495 will retrieve the file from the computer's disk drive and return encrypted data file 500 to Apache Web Server. Apache Web Server will take encrypted data file 500 and will add another level of encryption using the operating system's public key. The output of the file will be a double encrypted file. The first level of encryption being the inventive downloadable computer application's public key and the second level of encryption being the operating system's public key. Encrypted data file 500 is transported from Apache to the operating system via the Internet. Once the file has been received by the operating system, the operating system will decrypt the file using the operating system's private key. The output will be the original encrypted data file 500. Encrypted data file 500 will be passed to the inventive downloadable computer application. The encrypted data file will be stored on the operating system device as an encrypted file. The operating system protects encrypted data file 500 by restricting any other operating system applications on the computer device from accessing each other's files.

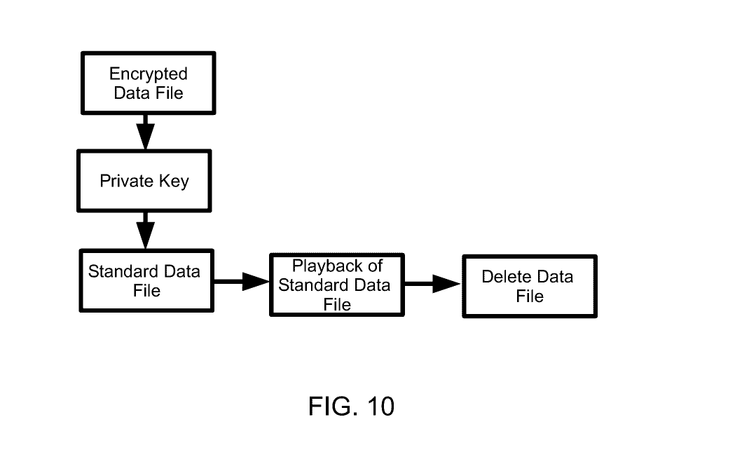

FIG. 10 illustrates the method playback of an encrypted data file within the inventive system. During playback, the encrypted data file will be decrypted using private key at step 550. Private key 550 will be bundled with the a downloadable computer application and stored securely in a protected database. The decrypted data file will be stored on the operating system device's disk drive during playback. Once playback has been completed, the decrypted data file will be deleted from the disk drive.

While illustrative embodiments of the invention have been described, it is noted that various modifications will be apparent to those of ordinary skill in the art in view of the above description and drawings. Such modifications are within the scope of the invention which is limited and defined only by the following claims.

1. A method of music file encryption and decryption comprising:
a. Generating a first public digital key and a first private digital key;
b. Encrypting a music file with said first public key;
c. Uploading said first public key encrypted music files to a server;
d. Storing said first public key encrypted music files in said server;
e. Packaging said first private key into a database file in a downloadable computer application;
f. Downloading said downloadable computer application with said packaged first private key onto a computer device;
g. Connecting said computer application with said server via a web server and a computer operating system which communicate using HTTP;
h. Requesting, via said computer application, that said first public key encrypted music file stored on said server to be sent to said computer device;
i. Encrypting said first public key encrypted music file with a second public key by said web server;
j. Sending said first and second public key encrypted music file from said server to said computer operating system through said web server;
k. Decrypting said second public key by said operating system using a second private key obtained via said HTTP communication process;
l. Downloading said first public key encrypted music file to said computer device;
m. Storing said first public key encrypted music on said computer device;
n. requesting to access said first public key encrypted music file stored on said computer device by said computer application;
o. Decrypting said first public key encrypted music file stored on said computer device using said first private key packaged into said computer application;
p. Storing said decrypted music file on said computer device while said computer application plays said decrypted music file; and
q. Deleting said decrypted music file from said computer device once said computer application has completed playback of said decrypted music file.
